(19) United States
(12) Patent Application Publication
(10) Pub. No.: US 2017/0024520 A1
(43) Pub. Date: Jan. 26, 2017

(54) METHODS, PLATFORM AND SYSTEM FOR COLLECTING AND MANAGING VITAL DATA OF PATIENTS FOR HEALTHCARE ESTABLISHMENTS

(71) Applicant: ENOVACOM, Marseille (FR)

(72) Inventors: Jean-Baptiste MICHON, Blanquefort (FR); Mathieu ROULLET, Marseille (FR)

(73) Assignee: ENOVACOM, Marseille (FR)

(21) Appl. No.: 15/302,813

(22) PCT Filed: Apr. 8, 2015
(86) PCT No.: PCT/FR2015/050920

§ 371 Date: Oct. 7, 2016

(30) Foreign Application Priority Data
Apr. 8, 2014 (FR) 1453138

(51) Int. Cl. G06F 19/00

(52) U.S. Cl. CPC G06F 19/322; G06F 19/3487

(57) ABSTRACT

The invention concerns a system for collecting and managing vital data of patients delivered by measuring devices in a healthcare establishment. Such a system comprises a platform that collects and manages said data. The platform cooperates with a server of computerised patient files and with a plurality of communicating devices used by the healthcare staff. The platform comprises repositories of patients and measuring devices in order to control associations or dissociations of devices and patients. The platform generates and transmits requests to the server for relevant and complete updates of computerised patient files. The invention further concerns an administration device that interacts with the platform in order to supervise said measuring devices.

The invention relates to a system for collecting and managing primarily vital data or physiological data for patients received within a healthcare establishment, such as a hospital or clinic. More specifically, the invention relates to a platform responsible for enriching electronic or electronic medical records, using said data, while minimizing the human actions necessary to establish said files as well as the risks of assigning incorrect data. Owing to a particularly innovative design, the invention further allows dynamic and optimal management of the fleet of vital data measurement devices within a healthcare establishment and particularly effective follow-up for patients treated by that establishment.

Consolidating a patient's medical record is not easy. Indeed, this record includes a wide variety of administrative and therapeutic information. Beginning from patient intake within a healthcare establishment, during care of the patient, potentially with a plurality of departments and a plurality of practitioners, such as doctors, nurses or caregivers, until the patient is discharged, the need for all practitioners within the establishment to be able to have a current, relevant and comprehensive overview of the patient's information is only partially met. Furthermore, this need mobilizes a particularly time-consuming activity by healthcare staff. Staff are often pulled away from therapeutic procedures to try to consolidate patient records. Despite a certain willingness by the staff to do this, the current tools provided to collect, connect and record patients' administrative and medical data are unfortunately sources of inconsistencies, redundancies, errors or missing information within patient records.

Such a patient record, even computerized (Electronic Medical Record, EMR), indeed non-exhaustively encompasses all of the information regarding a patient's health, i.e., information held by practitioners who have contributed to developing and/or following up on a diagnosis, treatment or preventive action, and which has been subject to written exchanges between healthcare professionals, for example exam results, reports on consultations, procedures, explorations, therapeutic prescriptions, etc. A medical record is established for each patient hospitalized in a public or private healthcare establishment. It is entered and updated by a patient data server, generally dedicated to that establishment. Such a server can alternatively be remote, or even distributed over several sites. The patient's computerized medical record thus includes information formalized and collected during external consultations provided in the establishment, when admitted to the emergency room, or upon intake and during a hospital stay. It thus contains the letter from the physician at the source of a consultation or intake, the reasons for hospitalization, a search for history or risk factors, the type of care anticipated, the prescriptions given upon patient intake, information related to the care given, prescriptions established during consultations, and whether the latter are external or internal. The file further includes information relative to patient care during hospitalization, including the clinical condition, the care given and the vital data measurements delivered by measuring devices. The computerized medical file can further include information prepared at the end of the patient's stay. Throughout all of a patient's care, including if the patient receives an outpatient consultation, i.e., without the consultation leading to hospitalization, different healthcare staff members may provide care. Different devices for measuring vital data are also used. Different systems involving hardware and software solutions exist to record and date the collected vital data.

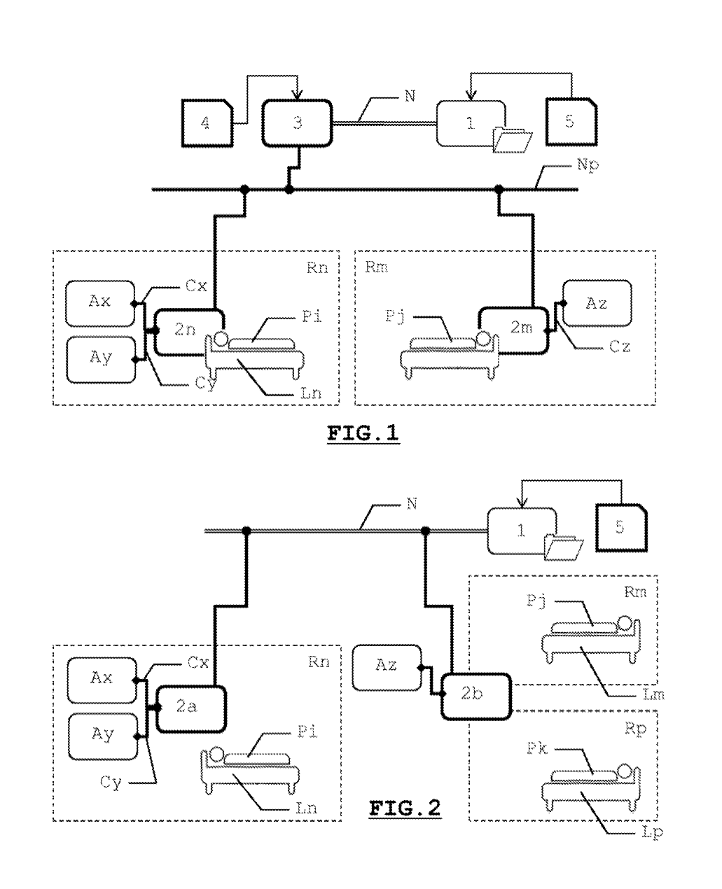

A first approach, illustrated briefly by FIG. 1, consists of having an electronic collection assistant 2n or 2m in each room, specifically at the foot of each bed provided to receive a patient. The function of such electronic assistant 2n or 2m consists of collecting vital data for that patient delivered by measuring device Ax, Ay or Az, for example a tensiometer, a medical ventilator or a perfusion pump, adapted or arranged to communicate with that electronic assistant. In connection with FIG. 1, a first patient Pi is hospitalized. He occupies a bed Ln in a room Rn, next to the window. A fellow patient Pk occupies a second bed Ln′ in the same room Rn, on the hallway side. This patient Pk and this bed Ln′ are not shown in FIG. 1. A second electronic assistant 2n′, also not shown in FIG. 1, is positioned near his bed Ln′. A third patient Pj receives a consultation without hospitalization. In the consultation office Rm, an electronic assistant 2m is present to collect vital data for patients during respective consultations. To collect vital data for said patients, this known technical solution requires providing a gateway between all of the vital data measuring devices and said electronic assistants. This gateway, which may potentially be different from one device to another, makes it possible to establish a communication between the devices Ax, Ay, Az and the electronic assistants 2n, 2n′ and 2m. Thus, according to FIG. 1, a tensiometer Az communicates via a wired gateway Cz with the assistant 2m, for example using a serial link according to standard RS-232. The assistant 2n in turn communicates with a perfusion pump Ax via a wired communication Cx implementing a USB (Universal Serial Bus). A ventilator Ay is in turn connected by a serial link Cy to the electronic assistant 2n via a cable. To implement such a wired communication Cx, Cy or Cz, connectors are generally used to ensure the physical relationship between a device and an electronic assistant on the one hand, and any communication port conversion on the other hand. Such a connector may further deliver a single connector identifier value so that the assistant can indirectly discern the connected device. If it is unable to make a measuring device communicating, an electronic assistant 2n, 2n′ or 2m includes an input interface to allow the healthcare staff member to record the data measured using said non-communicative device. Irrespective of the collection method, an electronic assistant records the vital data in internal memory means. According to a determined frequency, an electronic assistant sends, to a vital data aggregating server 3, the vital data potentially collected from several measuring devices during patient follow-up, for whom it remains “at the bedside”. The conveyance of said vital information to the aggregating server 3 is done using a communication network Np, which is generally wired and proprietary. To configure the data aggregation, or even to enrich the data or to be able to operate on the data before it is aggregated, the aggregating server cooperates with a console 4. An operator of said console 4 can thus configure or influence the aggregation of data received from an electronic assistant. Data previously collected by a plurality of electronic assistants is thus aggregated, then sent to an electronic medical record server 1 according to a normalized communication protocol N, in this particular case the HL7 (Health Level 7) protocol. HL7 is an organization defining an eponymous set of technical specifications determining the computerized exchanges of clinical, financial or administrative data between hospital information systems. The server 1 interprets the different messages coming from the aggregating server according to the HL7 protocol and initiates the update of patient medical records affected by the server 1.

Such a solution has many drawbacks. First, the need to install one or several electronic assistants in each room, depending on the number of beds present in said rooms, makes the solution very expensive. An electronic assistant must indeed be able to collect all of the vital data from various devices according to a plurality of communication channels. Such an assistant comprises a rich internal memory and input and output man-machine interfaces to respectively enter and view data recorded by the healthcare staff. Such a system must further be able to communicate with one or several data aggregating servers. The cost of an electronic assistant is therefore high in light of its many components. Its maintenance cost is furthermore also high. The man-machine interface is indeed generally fragile, because it is manipulated by different players, sometimes in clinical emergency situations. Updates of the operating system of the resources or application programs of a large fleet of electronic assistants is also tedious, complex and therefore expensive. These acquisition and maintenance costs are multiplied by the number of beds or consultation offices with which said electronic assistants are respectively associated. Furthermore, the deployment of a proprietary communication network, making it possible to create a relationship between each electronic assistant 2n or 2m and one or several aggregating server(s) 3, is cumbersome and restrictive based on the affected installations. The electronic assistants not being able to send directly to the server 1 including the patients' medical files, it is necessary to aggregate and consolidate the data collected by the electronic assistants via one or several aggregating servers. This equipment increases the cost of the installation described in FIG. 1. Furthermore, it is necessary to make the fleet of measuring devices communicate with a healthcare establishment so that said devices can exchange with the different electronic assistants, based on the communication modes supported by said electronic assistants. The acquisition, installation and maintenance of such a system are therefore complex and expensive. Furthermore, an electronic assistant does not directly “know” the identity of the patient occupying the bed with which said electronic assistant is associated. It also does not “know” the identity of the patient having undergone a consultation in an outpatient office. The association of the collected vital data with an affected patient's medical file is therefore not guaranteed. This is obtained indirectly, since the administrator of the aggregating server has a more or less up-to-date view of the assignment of a bed, and therefore of an electronic assistant to a patient. For consultations, reference is made to the consultations scheduled to consolidate this indirect “electronic assistant-patient” assignment. Indeed, the aggregating server 3 only knows the assignment of an electronic assistant to a consultation office. The risks of assignment errors of collected vital data to a computerized medical file is therefore high. In order to limit said risk, it is necessary to offset the technological limitations by using many human actions during the care given to record the identity of the patient, said identity being able to prove erroneous, or even inconsistent between two entries. Sometimes, the server 1 storing the patients medical files must be adapted or configured, for example using a supervision console 5, to consolidate or test the final assignment of the vital data to the patient files.

To try to bypass certain drawbacks from among those resulting from the design and exploitation of the solution illustrated by FIG. 1, a second vital data collection system has been designed to be implemented in healthcare establishments. Such a second approach is described in connection with FIG. 2. The “electronic assistants-aggregating server(s)” connection previously described is eliminated in favor of the use of a fleet of collection stations 2a or 2b respectively including personal computers potentially respectively positioned on moving carts to impart a certain mobility. Said collection stations 2a and 2b are, like the electronic assistants 2n or 2m described in connection with FIG. 1, generally each assigned to a room or a bed or a consultation office. Thus, as indicated in FIG. 2, three patients Pi, Pj and Pk respectively occupy beds Ln, Lm and Lp in separate rooms Rn, Rm, Rp. First and second collection stations 2a and 2b are assigned and positioned in the immediate vicinity of the beds occupied by said patients. A first station 2a is positioned in room Rn. The patient Pi, currently in bed in room Rn, is receiving care requiring checking vital data using two measuring devices Ax and Ay. These two measuring devices are suitable for being able to establish a wired communication with the collection station 2a. The connection and communication modes Cx and Cy of the devices Ax and Ay, respectively, with the collection station 2a are those traditionally used to connect any communicating device to a personal computer, for example a serial connection in accordance with standards RS-232 or USB. To ensure communication between a measuring device and a collection station, connectors are used to ensure the physical relationship between the two elements and the conversion of ports or communication buses, generally from standard RS-232 toward a USB standard. According to FIG. 2, the other two patients Pj and Pk are confined to bed in beds Lm and Lp respectively positioned in rooms Rm and Rp. This second collection solution makes it possible to convey the second collection station 2b in order to position it in the room Rm, occupied by patient Pj, then in room Rp, occupied by patient Pk. A nurse or doctor may connect a measuring device residing in one or the other of rooms Rm or Rp. This person may alternatively, jointly with said collection station 2b, convey a roaming measuring device Az, as indicated in FIG. 2. This device, for example a tensiometer, allows the nurse or doctor to test, successively or alternatively, physiological parameters of patients Pj, then Pk. The device Az is connected to the collection station 2b by a serial link Cz.

Unlike the electronic assistants 2n or 2m described in connection with FIG. 1, the collection stations 2a and 2b communicate directly with a server 1 administering computerized medical files for patients received in the healthcare establishment, for example according to an HL7 exchange protocol. To that end, the station operator connects the collection stations to connection terminals of a network N, said terminals being arranged in the rooms, hallways, or even in department or nurses' offices. Such a decentralized approach eliminates some of the drawbacks previously expressed. Thus, the choice of traditional equipment, i.e., personal computers to establish collection stations, in place of specific hardware to constitute the electronic assistants, decreases the acquisition costs. The direct communication between said collection stations 2a or 2b and the server 1 storing the patient medical files eliminate the need to deploy a proprietary communication network Np and thus decrease the deployment costs of the solution. However, such a solution has major drawbacks. It is first necessary to provide a sufficient network architecture N to ensure such exchanges between the collection stations 2a, 2b and the server 1. Furthermore, the connection problem inherent to electronic assistants with the measuring devices remains. Thus, measuring devices Ax, Ay and Az must be able to communicate with a collection station. The latter must reciprocally be able to connect to a communicating measuring device. When a device cannot be made communicating, the healthcare staff member must enter vital measurements or data using a suitable man-machine interface, for example a keyboard, or even a touchscreen. He must further be able to verify the proper record using an output interface such as a monitor. These input and output interfaces are expensive and fragile. The collection station must further include hardware means for ensuring the communication with the measuring device, but also with the server 1. An application program must be installed and kept up to date on all of the collection stations disseminated in the healthcare establishment. This second solution thus has similar drawbacks resulting from the acquisition, management and maintenance of a fleet of collection stations. Likewise, the assignment of a collection station to a patient is not always explicitly ensured. The collection station is assigned to a bed or an office. One therefore still uses many entries by healthcare staff, these entries not always being consistent with one another, when they are done by different healthcare providers. Ultimately, the solution described in relation with FIG. 2 provides very few advances.

The invention makes it possible to respond to the large majority of the drawbacks raised by the known solutions. By constituting a unique repository of patients, coupled to a repository of medical devices, said repositories including descriptors, or even additional data characterizing the structures, such as beds, rooms, care units, hosting patients or measuring devices, the invention allows healthcare staff to associate all patients, simply and certainly, with all measuring devices used to measure the vital data.

The many advantages contributed by the invention include that it makes it possible to:
greatly reduce the acquisition and maintenance costs of a vital data collection and management system, by eliminating any use of many devices respectively assigned to the beds, such as electronic assistants or collection stations previously described, and responsible for seeing to the communication with measuring devices and the deployment of said measurements toward a data aggregating unit;
connecting directly, through wired or wireless channels via a communication network, which is advantageously conventional, measuring devices to a platform centralizing the collection and management of vital data;
associating or dissociating, unambiguously, easily and in real-time, any vital data measuring device with respect to a patient receiving care or monitoring;
simplifying the actions of healthcare staff by using traditional communicating objects or devices, for example tablets, smart phones or computers, provided with contextual man-machine interfaces and adapted to the operations to be done;
determining, at any moment, the availability of the fleet of medical devices, and thus optimizing the management and dimensioning of said fleet;
sending relevant and complete update requests for electronic medical records, thus guaranteeing the traceability of the transmitted information, said requests in particular including the identification of the medical device, the identity of the patient, the timestamps for the collected vital data and the identity of the healthcare staff at the origin of the collection of the vital data;
decreasing, in light of the prior art, the acquisition and/or deployment costs of a patient data management and collection system, the maintenance costs of such a system as well as the training costs for healthcare staff using that system, said staff thus giving priority to their therapeutic or diagnostic gestures in their activity to the detriment of administrative follow-up.

To that end, the invention relates to a platform for collecting and managing vital data of a patient, said data being delivered by a medical measuring device. Such a measuring device is associated with a unique identifier and cooperates with said platform using one or several data messages. Such a platform further cooperates with an electronic medical record server and includes a processing unit. The unit cooperates with and implements:
means for receiving a data message and means for decoding a message deducing the identifier therefrom of the measuring device and the vital data delivered by the latter;
management means, cooperating with said means for decoding a data message, for selecting and aggregating vital data thus determined and producing an update request of an electronic medical record;
means for encoding such a request to update an electronic medical record and produce an update message sent to the electronic medical record server.

To control the associations or dissociations between measuring devices and patients and thus produce relevant and complete requests to update electronic medical records, such a platform further comprises:
means for storing a repository of patients including, for each patient, a record comprising a unique identifier characterizing the identity of said patient and a patient descriptor;
means for storing a repository of measuring devices including, for each measuring device, a record comprising the identifier of said device and a device descriptor;
means for receiving a care management message, coming from a device cooperating with the platform, encoding a request for association or dissociation of a measuring device and patient, said request including a unique identifier of the healthcare staff member initiating said association or dissociation, and means for decoding such a message and deducing the respective identifiers therefrom for the measuring device, the healthcare staff member and the patient affected by that request.

The means for managing such a platform are arranged to:
after decoding of a care management message by said means for decoding such a message, implement a care management method to record, in the means for storing the repository of devices, an association or dissociation of a measuring device and a patient, as well as the identifier of the healthcare staff initiating said association or dissociation;
after decoding of a data message by the means for decoding such a data message, implement a method requesting an update of the electronic medical record associated with the patient affected by the vital data thus collected by the platform, said update request method for an electronic medical record being suitable for integrating the unique identifier of the healthcare staff member and the update request of said electronic medical record.

The measuring devices can relay additional measuring information to a platform according to the invention. According to this alternative, a data message can include additional measuring data associated with the vital data of a patient. The means for decoding such a data message can advantageously be arranged to deduce said additional measuring data therefrom.

Such additional measuring data can include a timestamp and/or a measuring device description.

To make it possible in fine to facilitate the supervision of measuring devices, a platform according to the invention may further include means for recording a history of vital data collection, said history including a plurality of entries, and for which the management means can implement a traceability method to determine the content of a record of said history in response to the decoding of any data message.

The management means can then be adapted to implement a consultation method for a vital data collection history. The processing unit can include and implement means for encoding a view of the vital data collection history, said view resulting from the implementation of said method, in the form of one or several consultation messages. Said processing unit can also implement means for sending said message(s) to an administration device cooperating with the platform.

To facilitate the actions by healthcare staff, the management means can advantageously be adapted to implement a method for determining an association state of a measuring device. In this case, the processing unit can include and implement:
means for encoding said association state in the form of a device association state message;
means for sending such a message to a device cooperating with the platform.

The invention provides that the repository of measuring devices hosted by a platform according to the invention can be updated. The processing unit of such a platform may, to that end, include and implement means for receiving an administration message coming from an administration device cooperating with the platform, said message encoding an update request of the repository of devices, said request including a unique identifier of a measuring device and a descriptor of said measuring device. The same is true for means for decoding such a message and deducing the identifier and descriptor of the measuring device affected by the request therefrom. The management means can further be arranged so as, after decoding of an administration message by said means to decode such a message, to implement an update method of the repository of devices to create a new record associated with the measuring device or to update a record previously associated with the latter.

The invention provides that the repository of patients that is hosted by a platform according to the invention can in turn be updated. The processing unit can to that end include and implement:
means for receiving a patient follow-up message coming from an electronic medical record server cooperating with the platform, said message encoding a request to update the repository of patients, said request including a unique identifier of a patient and a descriptor of said patient;
means for decoding such a message and deducing the identifier and descriptor therefrom of the patient affected by the request.

To ensure such an update of the repository of patients, the management means may be arranged so as, after decoding of a patient follow-up message by said means for decoding such a message, to implement a method for updating the repository of patients to create a new record associated with the patient or to update a record previously associated with the latter.

In order to adapt and configure a platform according to the invention, irrespective of the alternative embodiment selected, said platform may include program memory means to save a computer program including a plurality of program instructions which, when executed or interpreted by the processing unit, cause the implementation of a method accessing, in write and/or read mode, the memory means of the platform.

As an example, a care management method, implemented by the management means of the processing unit of a platform according to the invention, can include, in response to the decoding of a care management message encoding a request in association with a measuring device and patient, steps for:
looking in the repository of devices for a record comprising the device identifier previously deduced from said care management message;
writing, in said record, an association information with a record of the repository of patients, said record including the patient identifier and the identifier of the healthcare staff member, also previously deduced from said care management message.

Alternatively, such a care management method can include, in response to the decoding of a care management message encoding a request for dissociation of a measuring device and a patient, steps for:
looking, in the repository of devices, for a record comprising the device identifier previously deduced from said care management message;
erasing or eliminating, in said record, the association information with a record of the repository of patients, said record including the patient identifier and the identifier of the healthcare staff member, also previously deduced from said care management message.

After having collected vital data, a platform according to the invention can generate an update request of an electronic medical record. An update request method for an electronic medical record, implemented by the management means of the processing unit of the platform according to the invention, may include steps for:
looking, in the repository of devices, for a record comprising the device identifier deduced from the data message;
reading the association information designating a record of the repository of patients and the identifier of the healthcare staff member initiating the association of the measuring device and the patient;
looking for said associated record in the repository of patients and reading the identifier of the patient contained in said associated record;
generating an update request of the electronic medical record including the identifier of the patient, the identifier of the healthcare staff member and the vital data deduced from the data message previously decoded;
controlling the means for encoding such a request to update an electronic medical record and producing an update message sent to the electronic medical record server.

To authorize a revision of the repository of measuring devices, the invention provides a method for updating said repository of devices. Such a method is implemented by the management means of the processing unit of a platform according to the invention, in response to the decoding of an administration message. Such a method may include steps for:
looking in the repository of devices for a record comprising the device identifier previously deduced from the administration message;
in the affirmative, updating the descriptor of the measuring device in said record;
in the negative, creating a new record in the repository of devices and writing the identifier of the device therein as well as the descriptor of said device, previously deduced from the administration message.

If the platform is able to constitute a history of the collected data, the invention provides a traceability method, implemented by the management means of the processing unit of such a platform. The latter includes steps for:
creating a record in the means for storing the history;
writing, in said record, all of the elements of said data message;
looking, in the repository of devices, for the record including the device identifier deduced from the data message;
reading the association information of said record and the identifier of the healthcare staff member initiating the association of the device and the patient;
looking for the associated record in the repository of patients;
if the latter exists, reading the identifier of the patient affected by the data measurement collection;
writing, in the record of the history, said identifier of the patient and said identifier of the healthcare staff member.

In order for a platform to be able to allow supervision of measuring devices via an administration device cooperating with said platform, the invention provides a method for consulting a vital data collection history, said method being implemented by the management means of the processing unit of the platform. Such a method then includes steps for:
accessing, in read mode, the means for storing a vital data collection history;
constituting a predetermined view of fields of each record;
controlling the means to encode such a view and producing a consultation message.

To authorize a revision of the repository of patients, the invention provides a method for updating said repository of patients. Such a method includes steps for:
looking, in the repository of devices, for a registration comprising the identifier of the patient previously deduced from the patient follow-up message;
in the affirmative, updating the descriptor of the patient in said record;
in the negative, creating a new record in the repository of patients and writing the identifier of the patient therein, as well as the descriptor of the patient, previously deduced from the patient follow-up message.

The invention further provides a method for determining an association status of a measuring device. This method, implemented by the management means of the processing unit of a platform according to the invention, may include steps for:
accessing, in read mode, the means for storing the repository of devices;
constituting a predetermined view of the fields of each record;
controlling the means to encode such a view and producing an association status message of the device.

To be able to configure and maintain such a platform, the invention provides a computer program including a plurality of program instructions which, when executed or interpreted by the processing unit of the platform, cause the implementation of one of the above methods, said program being able to be loaded in the program memory means of said platform.

According to a second object, the invention relates to a communicating device intended to be used by a healthcare staff member in order to record an association or dissociation of a measuring device and a patient.

The latter includes:
means for cooperating with a platform for collecting and managing vital data of a patient according to the invention;
a man-machine input interface for translating a selection action of said healthcare staff member into a determination of an identifier of a measuring device, an identifier of the patient, an association or dissociation operation of said measuring device and said patient as well as a unique identifier of said healthcare staff member;
a processing unit cooperating with said means for cooperating with a platform and said man-machine input interface.

The processing unit of such a device is suitable for carrying out a method for generating and sending a care management message including a request to associate or dissociate a vital data measuring device and a patient, said request including the identifier of the healthcare staff member, the identifier of the measuring device, the identifier of the patient, the association or dissociation operation of said measuring device and said patient initiated by the healthcare staff member.

To help said healthcare staff member in his action, such a communicating device may advantageously further include a man-machine output interface cooperating with the processing unit of the device. The means for cooperating with the platform can then be arranged to receive a device association status message coming from the platform and encoding an association status of a measuring device. The processing unit of the communicating device can be arranged to implement an association status consultation message of a measuring device in response to the receipt of said device association status message.

The method for generating a care management message encoding a request to associate or dissociate a vital data measuring device and a patient, said method being implemented by the processing unit of a communicating device according to the invention, includes steps for:
steering the man-machine input interface translating a selection action by a user to determine the unique identifier of a measuring device, the unique identifier of a patient, the association or dissociation operation of said measuring device and said patient and the identifier of the healthcare staff member initiating said association or dissociation;
depending on the determined association or dissociation operation, respectively producing a request to associate or dissociate the measuring device and the patient whose respective identifiers have been determined, said request including the identifier of the healthcare staff member initiating said association or dissociation;
encoding said request and producing a care management message;
controlling the sending of said message by the means for cooperating with the platform.

The method for consulting an association status of a measuring device, said method being implemented by the processing unit of a communicating device according to the invention, includes steps for:
following the receipt of an association status message of a device, decoding such a message and deducing therefrom the identifier of said measuring device, the identifier of a patient associated with said device and the identifier of the healthcare staff member initiating said association, or a predetermined value reflecting a non-association with a patient;
controlling the outputting of said identifiers and/or predetermined value by the man-machine output interface for a user of the communicating device.

To adapt such a communicating device, the invention further provides a computer program including a plurality of program instructions which, when executed or interpreted by the processing unit of the communicating device according to the invention, cause the implementation of a method above, said communicating device further including memory means within which the program can be loaded.

According to a third object, the invention relates to an administration device. Such a device may make it possible to initialize the repository of measuring devices hosted by a platform according to the invention.

Such a device includes:
means for cooperating with a platform for collecting and managing vital data according to the invention;
a man-machine input interface for translating a selection action by a user of said administration device into a determination of an identifier of a measuring device and a descriptor specific to said measuring device;
a processing unit cooperating with said means to cooperate with the platform and said man-machine input interface.

The processing unit of such a device is suitable for implementing a method for generating and sending an administration message, said message encoding a request to update the repository of devices of the platform.

Such a device may further make it possible to supervise the fleet of measuring devices.

In this case, such an administration device may include a man-machine output interface cooperating with its processing unit. The means for cooperating with the platform may also be arranged to receive a consultation message coming from the platform and encoding a view of the collection history of vital data from the platform. The processing unit of the administration device is then arranged to implement a method for supervising the operation of measuring devices, in response to the reception of said consultation message.

A method for generating an administration message, said method being implemented by the processing unit of an administration device, includes steps for:
steering the man-machine input interface reflecting a selection action by a user of the administration device to determine an identifier and a descriptor of a measuring device;
producing a request to update the repository of devices of the platform including said identifier and descriptor of the measuring device;
encoding said request in the form of an administration message;
controlling the sending of said message by the means to cooperate with the platform.

A method for supervising the operation of measuring devices, said method being implemented by the processing unit of an administration device according to the invention, includes steps to:
after receipt of a consultation message from the platform, decode such a message and deduce therefrom a view of the vital data collection history of the platform;
implement processing of said view and produce synthesis data thereof;
control the outputting of said synthesis data by the man-machine output interface for a user of said administration device.

To adapt an administration device, the invention further relates to a computer program including a plurality of program instructions which, when executed or interpreted by the processing unit of such an administration device, cause the implementation of one of the methods above, said administration device further including memory means within which the program can be loaded.

The invention lastly relates to a system for collecting and managing vital data of a patient comprising:
a server for storing a plurality of electronic medical records;
a plurality of measuring devices each delivering vital patient data;
a platform for managing and collecting said vital data, according to the invention, cooperating with said measuring devices and said server;
one or several communicating devices adapted according to the invention and cooperating with the platform.

Such a system may further comprise an administration device adapted according to the invention and cooperating with the platform.

Other features and advantages will appear more clearly upon reading the following description, related to one example embodiment provided for information and non-limitingly, and in reference to the figures that accompany it, in which:

FIGS. 1 and 2, already described, respectively describe two known systems for collecting and managing vital data of patients;

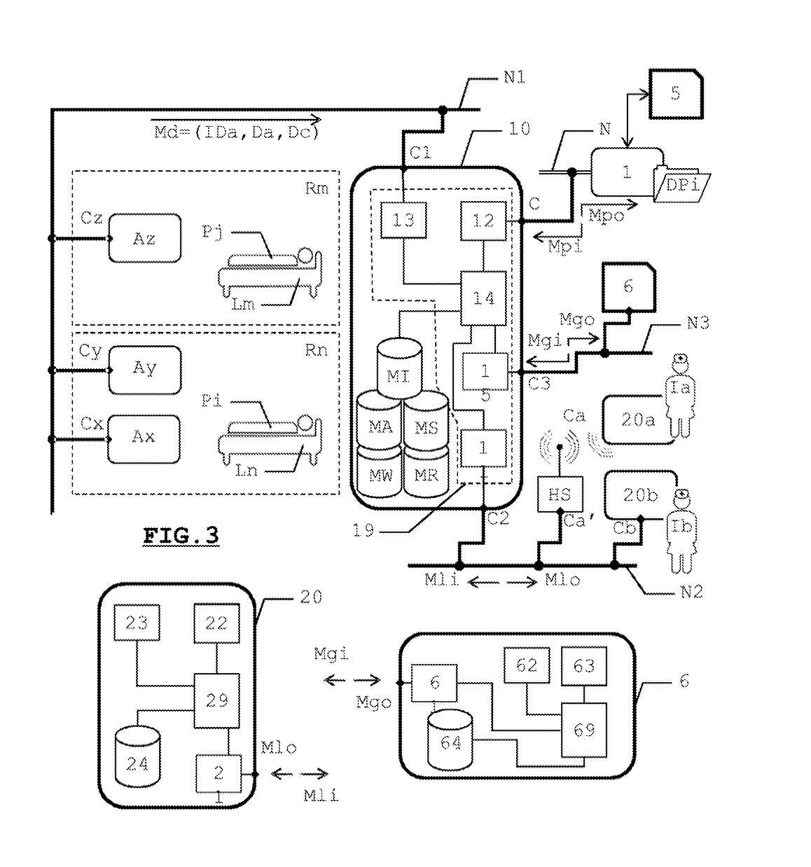

FIG. 3 shows one preferred architecture of a system for collecting and managing vital patient data according to the invention;

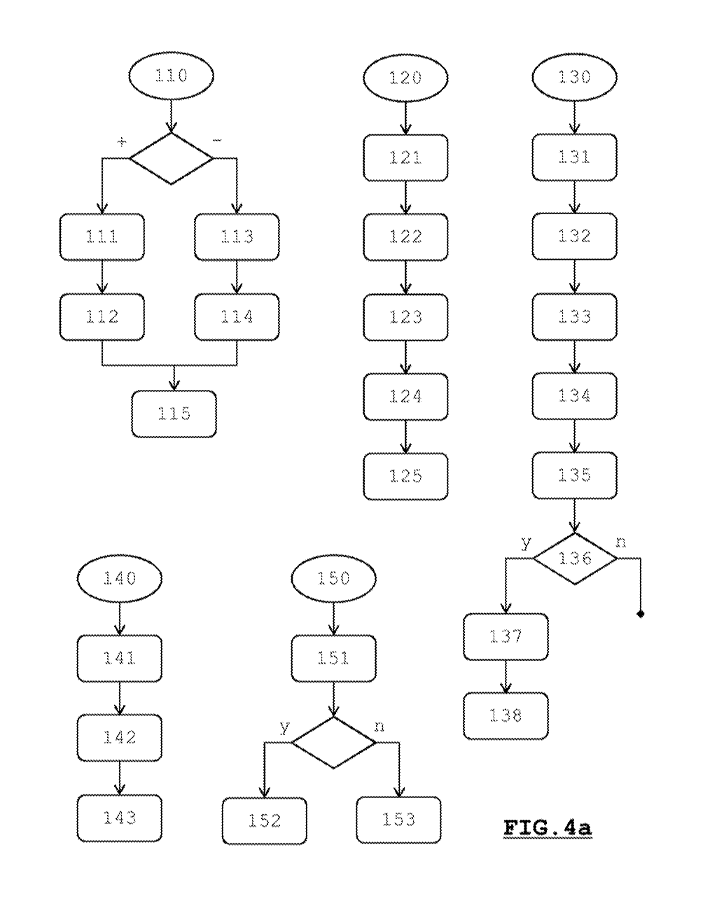

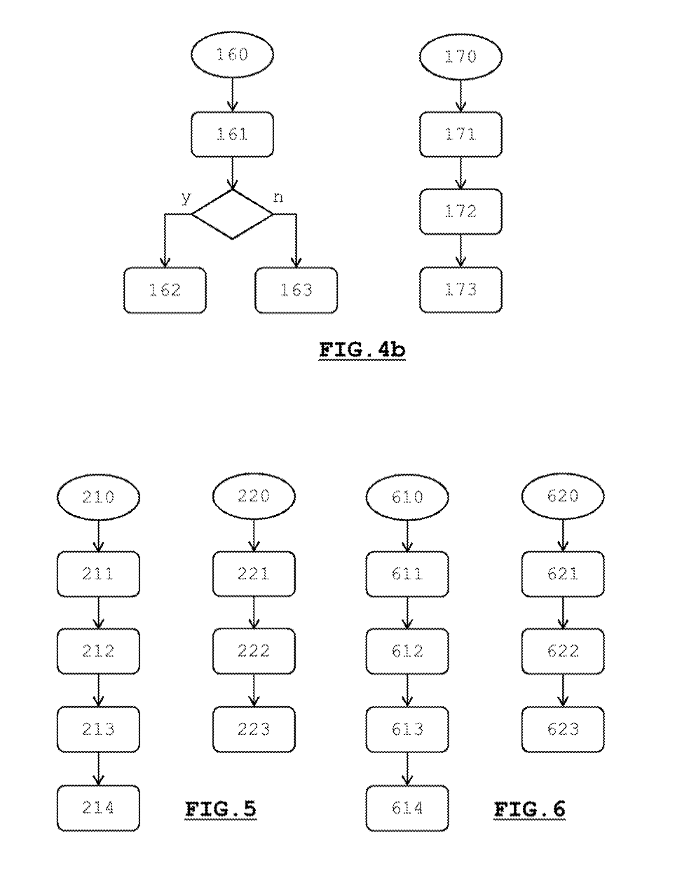

FIGS. 4a and 4b illustrate methods implemented by the processing unit of a platform for collecting and managing vital patient data according to the invention;

FIG. 5 illustrates two methods implemented by the processing unit of a communicating device with a platform for collecting and managing vital patient data according to the invention;

FIG. 6 illustrates two methods implemented by the processing unit of an administration device cooperating with a platform for collecting and managing vital patient data according to the invention.

Like the systems previously described in connection with FIGS. 1 and 2, the invention relates to a system for collecting and managing vital patient data for patients received within a healthcare establishment.

As a non-limiting example, such a system is illustrated by FIG. 3. The healthcare establishment in question has a plurality of rooms or consultation offices. Thus, the first patient Pi is in a bed Ln within a room Rn. The second patient Pj occupies a bed Lm in a separate room Rm. These two patients are receiving care. Healthcare staff members Ia and Ib, for example nurses, are responsible for providing medical follow-up. Such staff thus uses a plurality of medical measuring devices Ax, Ay, Az. As examples illustrated by FIG. 3, such equipment consists of a tensiometer, a medical ventilator, a perfusion pump or any other device able to deliver vital data.

Contrary to the solutions previously described in connection with FIG. 1 or 2, said devices do not communicate with electronic assistants or a collection station dedicated to one bed or one room. According to the invention, such devices are able, natively or after adaptation, to communicate via a communication network N1, for example of the Ethernet type. To make a potentially non-communicating device, or a device incompatible with such a communication route, communicating, the invention provides that it is possible to use a connector physically connecting the measuring device to the network N1. Such a connector converts the communication ports of the measuring device and the network N1, respectively, for example an output port with standard RS-232 toward an input port with standard RJ-45. The connector can further perform a conversion of communication protocols. Thus, any measuring device can send vital data of a patient over the network N1 via a data message Md. According to the affected measuring devices, the respective contents of the data messages can be different. Thus, the devices Ax, Ay and Az communicate through the network N1 via network connections Cx, Cy and Cz that may be different.

Like the solutions described in connection with FIG. 1 or 2, the system for collecting and managing vital patient data according to the invention, illustrated in FIG. 3, includes a server 140 for electronic medical records DPi. This server 1 communicates with third-party devices via a wired communication network N. As one preferred example, such a server 1 includes two half-connectors. A first half-connector is arranged to receive messages Mpo to update electronic medical records. The second half-connector is arranged to send messages Mpi conveying information related to the patients having an electronic file, for example, upon intake of the patient or during the transfer of a patient from a first care unit to a second care unit. According to the invention, such messages Mpi and/or Mpo are advantageously according to standards IHE (Integrating the Healthcare Enterprise) and HL7. The messages are thus advantageously conveyed by protocol of the MLLP (Minimal Lower Layer Protocol) type.

Such a standard describes the nature of the fields or elements that must be included in a request to update an electronic medical record. Aside from vital data, such a request requires, to be unambiguous, in particular the specification of the identifier of the patient from whom said data comes, an identifier of a healthcare staff member responsible for initiating the measurement of the vital data and a timestamp of the latter. As previously explained, known solutions do not make it possible to fill in all of these fields. As a reminder, a collection station 2a or 2b, illustrated in FIG. 2, does not know the identity of the patient from whom it receives vital data from the measuring device. The same is true for the electronic assistant 2n or 2m, illustrated in FIG. 1, or the aggregating platform 3 cooperating with electronic assistants 2n, 2m. According to the prior art, the “patient identity” field, which is nevertheless crucial to guarantee the ownership of the measured vital data, is not entered or includes a default value. The electronic medical record server, including a view of the structures and locations of the patients, must consolidate the data by trying to bring together a repository of patients, a repository of structures, such as a care unit, rooms, beds, with the identifiers of the measuring devices or electronic assistants, or even collection stations, etc. The risk of inconsistency or assignment errors during this consolidation operation is high.

The invention eliminates this drawback. Complete and unambiguous update requests are thus sent to the server 1 of the electronic medical records DPi. Indeed, unlike the known solutions, a system according to the invention includes a single platform for collecting and managing all of the vital data delivered by the measuring devices. As indicated in FIG. 3, the latter Ax, Ay, Az communicate directly, by communication channels Cx, Cy, Cz, with such a platform 10 via the communication network N1. The platform 10 furthermore cooperates with the server 1, which enters and administers the electronic medical records DPi. The platform 10 can also cooperate with one or several communicating devices 20a or 20b, used by healthcare staff members providing care for patients. To that end, the platform 10 dialogues with these devices via a communication network N2. As described below, these devices are advantageously traditional communicating objects, such as, by way of non-limiting examples, communicating tablets, smartphones or laptop computers. By using these devices, the healthcare staff members inform the platform 10 of any association or dissociation of a measuring device and patient. Like an orchestra conductor, the platform 10 collects the data messages Md sent by the measuring devices, associates the collected vital data with the identifier of the relevant patient, or even an identifier of the healthcare staff member who initiated the measurement of said vital data. Said platform selects certain collected vital data, aggregates them and produces relevant update requests for electronic medical records DPi intended for the server 1.

We will now study the hardware and software architecture of such a platform 10 for collecting and managing vital patient data.

As indicated in the example illustrated by FIG. 3, a platform 10 for collecting and managing vital data Da of a patient Pi or Pj includes a processing unit 19, for example a microprocessor or microcontroller. This processing unit 19 cooperates, for example via an internal wired bus, and implements means C1 for receiving data messages Md delivered by the medical measuring devices communicating via the network N1. This communication port C1 provides the connection of the platform to said network N1. The processing unit 19 cooperates with and implements means 13 for decoding such data messages Md. As previously mentioned, the data messages Md generally have respective contents and structures that vary depending on the models or types of measuring devices. Aside from a unique identifier IDa characterizing the measuring device having initiated the message, measured vital data Da, a message Md according to the invention advantageously includes additional data Dc. Such additional data comprise a device descriptor that specifies the type or model of the device. This descriptor can be sent by the measuring device as is or by the optional connector connecting said device to the network N1, if said device can directly generate a message Md intelligible by the platform 10. Alternatively, a message Md may not include such a device descriptor. This may advantageously be deduced by the processing unit 19 from information comprised in a repository of measuring devices MA, this repository being hosted by memory means cooperating with said processing unit 19. According to this alternative, the identifier of the measuring device contained in a data message is sufficient for the processing unit to be able to query said repository MA, determine the descriptor of the device affected by the data message and thus adapt the means 13 so that the latter decode the message Md.

According to one preferred embodiment, said means 13 consist of one or several computer libraries that can be implemented by the processing unit 19. According to the descriptor of a measuring device, whether the latter is conveyed by the data message or entered in the repository of devices MA, the processing unit 19 implements the appropriate computer library. The means 13 are thus able to decode any received message Md, irrespective of the measuring device at the origin of the message. The latter discriminate or deduce the vital data Da, the identifier IDa, or even additional data Dc of said message. Such a message Md may further be encoded to authenticate or even encrypt the content of the message, according to any known means, by the measuring device or the optional connector connecting the device to the network N1. In this case, the means 13 are able to implement reciprocal functions necessary to verify the authenticity of the message, or to decrypt it, prior to decoding of the message as such.

Whether or not such a device descriptor is recorded in a repository of devices MA, said repository of devices is necessary for the operation of a platform 10 according to the invention.

The repository of measuring devices MA includes, for each measuring device, such as one of the devices Ax, Ay or Az, a record comprising the identifier of said device IDa, or even a descriptor. The repository of devices MA may further specify a particular processing that the processing unit 19 must apply to the data collected by the platform and coming therefrom.

The repository of measuring devices MA may be pre-established or predefined during commissioning of the platform 10. It may also advantageously be updated by a manager of a fleet of measuring devices, via a console or administration device 6 cooperating with the platform 10, such as during acquisitions, declassification or maintenance operations related to said fleet. The platform 10 then includes means C3 for receiving administration messages Mgi coming from such an administration device 6 cooperating with the platform 10, for example via a communication network N3. Such an administration message encodes an update request of the repository of devices MA. Later, we will study the potential cooperation between such an administration device 6 and the platform 10.

To ensure the management and administration of the data decoded by the means 13, the processing unit 19 implements management means 14. Like the means 13, the management means 14 can advantageously also consist of one or several computer libraries determining operations that the processing unit can carry out. As non-limiting examples, such operations can lead to filtering certain vital data that one wishes to ignore or select, aggregating or even consolidating it so as, in fine, to produce an update request of an electronic medical record DPi of the server 1. The management means 14 can thus implement a plurality of rules or management methods for the vital data collected and decoded by the means C1 and 13, respectively.

A collection and management platform according to the invention 10 further includes a repository of patients MI. The latter is stored by memory means cooperating with the processing unit 19 of the platform 10. The repository of patients MI includes, for each patient, such as the patient Pi or Pj, a record comprising a unique identifier characterizing the identity of said patient. It may further include a patient descriptor. This may include information related to the hosting of said patient: a room, a bed, a care unit. The description may further include distinctive signs such as the first names, last names or sex of the patient, etc. Alternatively, the elements related to the host structure, such as the care unit, the bed, the room, etc. may be subject to a repository of structures also stored by the platform. In this case, the descriptor of the patient includes one or several references, or association information, toward said structure repository.

The presence of repositories of patients MI and devices MA constitutes one essential difference with respect to the known solutions. Indeed, the platform 10 embodies and records any association or dissociation of a measuring device and a patient. Such an association advantageously consists of associating the record of the repository of patients MI, including the identifier of said patient, with the record of the repository of devices MA, including the identifier of said measuring device. Such an association may be done by any means, depending on whether the repositories constitute record tables of a database or sequenced structures or record files. According to one preferred embodiment, when a measuring device and a patient are considered to be associated, the record of the repository of measuring devices MA, which comprises the identifier of the associated device, includes association information designating the record of the repository of patients MI that includes the identifier of the associated patient. This information may consist of the value of said identifier of the patient or of a reference or pointer toward said record including the identifier of the patient within the repository of patients MI. Alternatively, memory means, cooperating with the processing unit 19 of the platform 10, can save a data structure or table including pairs of references respectively designating entries of the repositories of devices MA and patients MI associated therewith.

The repository of patients MI may be pre-established and/or advantageously updated as patient intakes, discharges or care unit transfers occur. To that end, a platform 10 according to the invention may advantageously cooperate with a server 1 for electronic medical records DPi and receive messages Mpi from the latter. Such a message Mpi encodes an update request of the repository of patients MI. Later, we will outline this potential interaction between the electronic medical record server and a platform according to the invention.

In order for a platform according to the invention, such as the platform 10 described in connection with FIG. 3, to translate and enter an operation initiated by a healthcare staff member Ia or Ib seeking to associate or dissociate a medical measuring device and a patient, said platform includes means C2 for receiving a care management message Mli. According to FIG. 3, such a message Mli comes from a device 20, 20a or 20b cooperating with the platform 10. Such a message makes it possible to encode a request to associate or dissociate a measuring device and a patient. As one preferred example, such a communicating device 20a or 20b, a functional architecture of which is described in connection with a device 20, dialogues with the platform via a communication network N2. Such a network may be a wired network, for example of the Ethernet type. To that end, the device 20b, for example in the form of a laptop computer, communicates via a wired connection Cb. Conversely, the device 20a, for example a smart phone or a tablet, communicates wirelessly Ca, for example according to the Wi-Fi or Bluetooth communication protocols, via a network access point HS ensuring the protocol conversion of the wireless channel Ca into a wired channel Ca′.

Upon receipt of a message Mli by the receiving means C2, the processing unit 19 of the platform according to the invention includes and implements means 11 for decoding such a message. Such hardware and/or software means deduce the respective identifiers of the measuring device and the patient affected by the association or dissociation request. In the same way as for a data message Md, a care management message Mli may be encoded to be signed and/or encrypted by the communicating device 20, 20a or 20b having sent said message. In this case, the decoding means 11 include the reciprocal functions to verify the signature of the sending device and/or to decrypt the message Mli.

After decoding of a care management message Mli by said decoding means 11, the processing unit 19 commands the implementation of a method 110 for managing care via the management means 14. In connection with FIG. 4a, this method records, in the means for storing the repository of devices MA, an association or dissociation of a measuring device and a patient.

If the request deduced by the means 11, during the decoding of the care management message Mli, is an association request (embodied by a “+” sign in FIG. 4a) of a measuring device and patient, such a method 110 advantageously includes:
a step 111 for looking, in the repository of devices MA, for a record comprising the identifier of the measuring device previously deduced from said care management message Mli;
a step 112 for writing, in said record, association information with a record of the repository of patients, said record including the patient identifier also previously deduced from said care management message Mli.

Conversely, if the decoding of the care management message Mli falls under a dissociation request (embodied by a “−” sign in FIG. 4a) of the measuring device and patient, said care management method 110 advantageously includes:
a step 113 for looking, in the repository of devices MA, for a record comprising the identifier of the device previously deduced from said care management message Mli;
a step 114 for erasing or eliminating, in said record, the association information with a record of the repository of patients MI, said record including the patient identifier also previously deduced from said care management message Mli.

Such an erasure of the association information can consist of writing a predefined value meaning “non-association”.

The repositories MI and MA thus provide information to the platform 10, on the one hand of the measuring devices able to send data messages Md including vital patient data, but also of patients from whom said vital data comes that is received by the platform, said data coming from said measuring devices.

In this way and unlike the solutions known and described in connection with FIG. 1 or 2, the management means 14, implemented by the processing unit 19 of a management and collection platform 10 according to the invention, are able to produce one or several requests to update electronic medical records whereof the completeness and “data-patient” consistency are unparalleled relative to the state of the art.

To still further complete a request sent to the server 1 to update electronic medical records DPi, the invention provides that the care management messages Mli generated by communicating devices 20, 20a or 20b, used by healthcare staff members Ia or Ib having initiated an association or dissociation operation of a measuring device and a patient, can include the respective identifiers of said healthcare staff members Ia, Ib. Such an identifier of a healthcare staff member can be deduced by the decoding means 11. The method 110 implemented by the management means 14 then includes an additional step 115 for writing information in addition to the association information. This information may be the identifier of the healthcare staff member as such or a reference to a repository of healthcare staff members MS shown in FIG. 3.

A repository of healthcare staff members MS can advantageously be stored by memory means cooperating with the processing unit 19 of the platform 10. Said repository MS can include, for each healthcare staff member, such as a nurse Ia or Ib, a record comprising a unique identifier characterizing the identity of said healthcare staff member. It may further include a descriptor for example comprising information related to the care unit to which that staff member belongs or distinctive signs such as first names, last names or sex, station, etc. Alternatively, the elements related to the care unit may be subject to a repository of structures also stored by the platform. In this case, the descriptor of the healthcare staff member includes one or several references, or several pieces of association information, toward said repository of structures.

One example of the generating of such an update request of an electronic medical record DPi by the management means 14 may follow, after decoding of a data message Md by the decoding means, the implementation of a method 120 for requesting an update of an electronic medical record DPi, said record being that of the patient affected by the vital data thus collected by the platform 10.

In connection with FIG. 4a, such a method 120 can advantageously include:
a step 121 for looking, in the repository of devices MA, for a record comprising the identifier IDa of the device deduced from a data message Md;
a step 122 for reading the association information designating a record of the repository of patients MI;
a step 123 for looking for said associated record in the repository of patients MI and reading the identifier of the patient contained in said associated record;
a step 124 for establishing a request to update the electronic medical record Dpi including the identifier of the patient and the vital data deduced from the data message Md previously decoded.

If the record associated with the measuring device designates or includes the identifier of a healthcare staff member Ia or Ib having initiated the association of the measuring device and the patient, step 124 for generating an update request of the electronic medical record DPi further incorporates said identifier into said request. Such an identifier of the healthcare staff member Ia or Ib can advantageously be read beforehand in step 122 in the record comprising the identifier IDa of the affected measuring device.

Under the action of the processing unit 19, the management means 14 can subsequently control means for encoding such an update request of an electronic medical record Dpi and produce an update message Mpo sent to the server 1 for electronic medical records Dpi. This action constitutes step 125 of the method 120.

Like the means for decoding 13 data messages Md or decoding 15 administration messages Mgi, or even for decoding 12 messages Mpi conveying patient-related information coming from the server 1, the means for encoding update requests for electronic medical records and producing messages Mpo may consist of a software library implemented by the processing unit 19. The messages Mpo are advantageously sent by means C to the server 1 according to the IHE and HL7 standards. The messages Mpo are thus advantageously conveyed using a protocol of the MLLP type. The encoding of the update requests for electronic medical records can be subject to encryption or a signature procedure of the platform to guarantee the confidentiality and/or authenticity thereof.

The invention further provides for the ability to form a history of vital data collected and managed by the platform. To that end, such a platform 10 further includes means MR for recording a vital data collection history. Such a history consists of a plurality of entries, and for which the management means 14 implement a traceability method 130 to determine the content of a record of said history in response to the decoding of any data message Md.

In connection with FIG. 4a, such a traceability method 130 may advantageously include:
a step 131 for creating a record in the means for storing the history MR;
a step 132 for writing, in said history, all of the elements deduced from said data message Md, for example the identifier IDa of the device, the vital data Da, additional measuring data Dc;
a step 133 for looking in the repository of devices MA, the record including the identifier of the device deduced from the data message Md;
a step 134 for reading the association information of said record;
a step 135 for looking for the associated record in the repository of patients MI, i.e., that designated by said association information;
if the latter exists, i.e., the response to the test 136 is “y”, a step 137 for reading the identifier of the patient affected by the data measurement collection Da;
a step 138 for writing said patient identifier in the record of the history.

As previously mentioned, the history may also include, in any record, the identifier of the healthcare staff member Ia, Ib having initiated the association of a measuring device and a patient jointly with the elements deduced from a data message. The step 134 may furthermore consist of reading, in said record, the identifier of the healthcare staff member Ia, Ib having initiated the association. Step 138 may in turn consist advantageously of writing, in the record of the history, said identifier of the healthcare staff member jointly with that of the patient.

According to one preferred embodiment, the additional measuring data Dc may include a timestamp of the vital data. Such a timestamp is then recorded in the history MR.

Such a history MR has different uses and may be subject to several processing operations implemented by the management means 14 of the processing unit 19 of the platform.

Said history MR may in fact be consulted by a communicating device 20, 20a or 20b of a healthcare staff member for therapeutic monitoring of the patient. It may further be consulted by a manager of a fleet of measuring devices to determine the usage rate of each device and thus optimize the management and/or maintenance of said fleet. In the latter case, the management means 14 advantageously apply predetermined criteria to offer only a partial view of said history, for example hiding any reference to a patient.

We will now study the different interactions between a platform according to the invention and different third-party devices, through the example described in FIG. 3.

A platform 10 cooperates via a communication network with a server 1 for electronic medical records DPi. We have already outlined the generating of update requests of electronic medical records DPi, encoded and sent to the server 1 in the form of messages Mpo by the means 12 and C.

We have previously mentioned that the repository of patients MI can advantageously be updated as patient intakes, discharges or transfers occur. To ensure such an update of said repository MI, the processing unit 19 includes and implements means for receiving C a patient follow-up message Mpi coming from the server 1. Such a message can be produced purposely by the server 1 to update the repository of patients MI. It is generally produced to communicate with the administrative stations of the care units and thus to inform the patient follow-up personnel within a healthcare establishment. The platform 10 is advantageously provided to listen to and intercept such a patient follow-up message Mpi. It can therefore intercept such a message, initialize and/or update the repository of patients MI. A patient follow-up message Mpi is therefore considered, “in the eyes” of the platform 10, to encode an update request of the repository of patients MI.

Said request includes a unique identifier of a patient Pi or Pj and a descriptor of said patient.

The management means 14 cooperate with hardware and/or software means 12, for decoding a patient follow-up message Mpi and deducing said identifier and said descriptor of the patient affected by the request therefrom. As a reminder, such a descriptor may include information related to the hosting of said patient: a room, a bed, a care unit. It may further include distinctive signs such as the first names, last names or sex of the patient.

After decoding a patient follow-up message Mpi, the management means 14 implement a method 150 for updating the repository of patients MI. This consists of creating a new record associated with the patient or updating a record previously associated with the latter in the repository of patients MI.

Thus, according to one preferred embodiment and illustrated in connection with FIG. 4a, the method 150 advantageously includes a step 151 for looking, in the repository of devices MA, for a record comprising the identifier of the patient previously deduced from the patient follow-up message Mpi. If such a record exists (embodied by a “y” in FIG. 4a), said method includes a step 152 for updating the descriptor of the patient in said record. It indeed involves the case of a patient being transferred into a new care unit. In the negative (embodied by a “n” in FIG. 4a), the method 150 includes a step 153 for creating a new record in the repository of patients MI and writing the identifier of the patient therein, as well as the descriptor of said patient. In this case, as a general rule, this involves a newly admitted patient.

To inform a platform 10 according to the invention of any association or dissociation of a measuring device and a patient, said platform cooperates with one or several communicating devices 20a or 20b, the latter sending it care management messages Mli. The invention further provides that the platform can inform said communicating devices, via device association status messages Mlo, of the availability of the measuring devices and thus facilitate the actions by healthcare staff members.

The functional architecture of such a device 20 is described in connection with FIG. 3. Ideally, each healthcare staff member has a communicating device. As a non-limiting example, FIG. 3 describes two healthcare staff members Ia and Ib respectively having communicating devices 20a and 20b. Alternatively, communicating devices are shared for a plurality of healthcare staff members. In order to decrease the acquisition and maintenance costs of the fleet of communicating devices, the latter are advantageously selected from among the traditional communicating objects, such as laptop computers, tablets or smartphones. They do not result from a specific design like the electronic assistants described in connection with FIG. 1.

A communicating device 20, 20a or 20b includes means 21 for cooperating with a platform 10 for collecting and managing vital data of a patient according to the invention. To that end, it is sufficient to use the traditional means to communicate, through a wired or wireless network. Such equipment can therefore be connected to the network N2 by a wired connection Cb via a cable including an RJ-45 port or via a wireless connection Ca, Ca′ of the Wi-Fi or Bluetooth type via a network access point HS.

A device 20 further includes a man-machine input interface 22 for translating a selection action by a healthcare staff member into a determination advantageously of an identifier of said healthcare staff number, an identifier of a measuring device, an identifier of a patient and an association or dissociation operation of said measuring device and said patient. Such an input interface 22 consists of a computer keyboard or a touchscreen for a tablet. Cooperating with the means 21 and 22, a device 20 includes a processing unit 29. This is the microprocessor or microcontroller of said device. Although conventional, the device 20 is suitable so that said processing unit can implement a method 210 for generating and sending a care management message Mli encoding a request to associate or dissociate a vital data measuring device and a patient. Such a method 210 is described, as an example, in connection with FIG. 5.

To that end, the processing unit 29 cooperates with memory means 24 within which a computer program can be loaded. Such a computer program includes a plurality of program instructions, which, when executed or interpreted by the processing unit 29, cause the implementation of a method for generating and sending a care management message Mli according to the invention.

In connection with FIG. 5, a method 210 advantageously includes a step 211 for steering the man-machine input interface 22 and translating a selection action by a user Ia or Ib into a measuring device identifier, a patient identifier, an association or dissociation operation of said measuring device and said patient, as well as, advantageously, an identifier of the healthcare staff member having initiated said association or dissociation operation. Such an action may, for example, consist of traveling through a menu or lists on the one hand having the patients residing in the care unit to which the healthcare staff member is assigned, and on the other hand, the measuring devices available within said care unit. The selection of a patient and a device, accompanied by a menu or an association or dissociation button, translates the gestures and intention of the healthcare staff member. Depending on the association or dissociation operation thus determined, the method 210 includes a step 212 for respectively producing a request to associate or dissociate the measuring device and the patient, the parameters of which are the respective identifiers previously determined. Said method 210 further includes a step 213 for encoding said request and producing a care management message Mli. Lastly, a step 214 controls the sending of said message Mli by the means for cooperating 21 with the platform 10.

In order to assist the healthcare staff member using the communicating device 20, the invention provides to output a view, in particular of the repository of devices MA, through a man-machine output interface 23 of said device 20. Such an interface 23 is preferably a monitor that includes a traditional communicating device 20. It could, alternatively or additionally, be a speaker or any other means able to retrieve content intelligible by said healthcare staff. In order to allow this assistance, the invention provides that the means 21 for cooperating with the platform, more specifically with the network N2, can further be arranged to receive and decode a device association status message Mlo from the platform 10. Such a message encodes an association status of a measuring device in the form of a view of the repository of devices MA.

To allow such decoding and interpretation, the processing unit 29 is arranged to carry out a method 220 for consulting the association status of a measuring device in response to the reception of said device association status message Mlo. As a non-limiting example, the retrieval of the view of the repository delivered by the platform 10 can be done via a web browser or via a graphic interface adapted to this retrieval function. The healthcare staff member can thus consult the association or non-association status of the measuring devices. Such a consultation can be a prerequisite for the implementation of the method 210, the latter becoming a “contextual” method if, for example, only the devices not associated with a patient are present in 211.

In connection with FIG. 5, such a method for consulting a measuring device association status, implemented by the processing unit 29, can advantageously include:
following the receipt 221 of an association status message of a device Mlo, a step 222 for decoding such a message and deducing therefrom the identifier of said measuring device, the identifier of a patient associated with said device, the identifier of the healthcare staff member having initiated said association of the measuring device and the patient, or a predetermined value translating a non-association with a patient;
a step 223 for controlling the retrieval of said identifiers and/or predetermined value by the man-machine output interface 23 for a user of the communicating device.

In the same way as for the method 210, the adaptation of a device 20, in particular if the latter is a traditional communicating object, consists of loading, in the memory means 24, a computer program that includes a plurality of program instructions, which, when executed or interpreted by the processing unit 29, causes the implementation of the method 220 for consulting the measuring device association status according to the invention.

A platform 10 for collecting and managing vital data according to the invention, described as a non-limiting example in connection with FIG. 3, is then in turn adapted to send such an association status message of a device Mlo encoding a view of the repository MA. More specifically, the management means 14 of the processing unit 19 are suitable for implementing a method 140 for determining an association status of a measuring device. Via said means 14, the processing unit 19 includes and implements means for determining, then encoding said association status in the form of a device status message Mlo. The means C2 are controlled to send such a message to a communicating device 20, 20a or 20b cooperating with the platform 10 via the network N2.

In connection with FIG. 4a, such a method 140 advantageously includes:
a step 141 for accessing, in read mode, the means for storing the repository of devices MA;
a step 142 for constituting a predetermined view of the fields of each record;
a step 143 for controlling the means 15 to encode such a view and producing a device association status message Mlo.

In connection with FIG. 3, after having studied the interactions between a platform for collecting and managing vital data 10 according to the invention and a server 1 for electronic medical records DPi, then with one or several communicating devices 20, 20a or 20b used by healthcare staff members Ia or Ib, let us now study the cooperation between said platform 10 and an administration device 6. The latter is generally used by a manager of a fleet of measuring devices. According to one preferred embodiment, it corresponds to a microcomputer, optionally portable, suitable for moving in a supervision console of said fleet. This device 6 further makes it possible to configure the platform 10 by initializing the repository of devices. As indicated in FIG. 3, such a device 6 includes a processing unit 69. It further includes means for cooperating 61 with a platform 10 via a communication network N3. To that end, the administration device 6 connects to said network N3 by a preferred wired channel C3. The administration device 6 could, however, favor a wireless route. To allow the manager to give instructions or parameters, a device 6 further includes a man-machine input interface 62, traditionally in the form of a keyboard and/or a pointing device. Such an interface 62 serves to translate, for example, an input action by the manager into a determination of an identifier of a measuring device and/or a descriptor specific to said measuring device. The processing unit 69 cooperates with said means to cooperate 61 with the platform 10 and said man-machine input interface 62. An administration device 6 can further include a man-machine output interface 63 cooperating with the processing unit 69. Such an interface 63 consists of a monitor, a printer or any other means making it possible to retrieve content for the user of the device 6.

The processing unit 69 is suitable, according to the invention, for implementing a method 610 for generating and sending an administration message Mgi able to be decoded and interpreted by the platform 10. Such a message can make it possible to encode a request to update the repository of devices MA of the platform 10. Reciprocally, said processing unit 69 can be adapted to implement a method 620 for supervising the operation of measuring devices, in response to the receipt of a consultation message Mgo from the platform 10. Such a message Mgo in particular makes it possible to use the history MR of the vital data collections constituted by the platform 10, by delivering a view of said history.

A first cooperation mode between the administration device 6 and the platform 10 consists of initializing or updating the repository of devices MA. In connection with FIG. 6, the method 610 implemented by the processing unit 69 advantageously includes a first step 611 for steering the man-machine input interface 62 translating an action or gesture by a user of the administration device 6. This step 611 makes it possible to determine an identifier of the latter and a descriptor of a measuring device. Such a descriptor may include a type or model. It may further specify any information, such as precisions, units of measure, etc., that the management means 14 of the platform 10 can use to implement management rules relevant to the vital data after collection thereof. The method 610 may further include a step 612 for producing a request to update the repository of devices MA of the platform 10, said request including, as parameters, said identifier and descriptor of the measuring device. The method 610 lastly includes a step 613 for encoding said request in the form of an administration message Mgi. Such a step may include a signature phase to authenticate the device 6 as the source of said message, or encryption. Lastly, the method 610 includes a step 614 for controlling the sending of said administration message Mgi by the cooperating means 61 to the platform 10.

In order to process such an administration message Mgi, the platform 10 is also adapted.

The processing unit 19 implements means C3 for receiving an administration message Mgi from an administration device 6 cooperating with the platform 10 via the network N3. The processing unit 19 also implements means 15 for decoding such a message and deducing the identifier thereof and the descriptor of the measuring device affected by the update request of the repository of devices. The management means 14 of the platform are arranged so as, after decoding an administration message Mgi, to implement a method 160 for updating the repository of devices MA. The purpose of such a method is to create a new record associated with a new measuring device or to update a record previously associated with a device already entered in said repository of devices MA.

Thus, in connection with FIG. 4b, such a method 160 advantageously includes a first step 161 for looking, in the repository of devices MA, for a record comprising the identifier of the device previously deduced from the administration message Mgi. If a record comprising the identifier of the device exists in said repository MA (embodied by a “y” in FIG. 4b), this means that the latter is known by the platform 10. The method 160 then includes a step 162 for updating the descriptor of the measuring device in said record. If no record comprises said identifier (embodied by a “n” in FIG. 4b), the method includes a step 163 for creating a new record in the repository of devices MA and writing the identifier of the device therein as well as the descriptor of said device. This step makes it possible to declare a new measuring device available to measure and deliver vital data.

A second interaction mode between a platform 10 and an administration device 6 according to the invention consists of supervising the use of the measuring devices and thus optimizing the maintenance and management of the fleet of devices.

In connection with FIG. 6, the method 620 for supervising the operation of measuring devices, implemented by the processing unit 69 of an administration device thus adapted, advantageously includes, following the reception of a consultation message Mgo coming from the platform 10, a first step 621 for decoding such a message and deducing a view therefrom of the history MR of the vital data collection of the platform 10. Such a view essentially uses the timestamp information, if it exists, of the vital data collections and the association unit. The view preferably conceals the identities of the associated patients for obvious confidentiality reasons. A method 620 further includes a step 622 to carry out a treatment of said view and producing synthesis data therefrom. Any processing may be considered within the meaning of the invention. The primary aim of the supervision is to dynamically monitor the device association rate and/or any other statistic useful for the manager. Lastly, the method 620 includes a step 623 for controlling the retrieval of said synthesis data via the man-machine output interface for the user of the administration device 6.

In the same way as for a communicating device 20, an administration device 6 is preferably a conventional object. To adapt the latter and make it able to communicate and interact with the platform 10, owing to the implementation in particular of the methods 610 or 620, the invention provides a computer program including a plurality of program instructions, which, when executed or interpreted by the processing unit 69 of an administration device 6, cause the implementation of one of said methods 610 or 620. Such a computer program is loaded in memory means 64 cooperating with said processing unit 69 so that the latter can use it.

To deliver a consultation message Mgo to an administration device 6 via the network N3, the platform 10 is adapted such that the management means 14 can implement a method 170 for consulting a history MR of the collection of vital data Da. The processing unit 19 of the platform, via the management means 14, implements means 15 for encoding a view of the collection history of vital data, said view resulting from the implementation of said method in the form of one or several consultation messages Mgo. The means C3 for sending said message(s) Mgo to an administration device 6 are controlled by the processing unit 19 to send said messages over the network N3.

Such a method 170 for consulting a history MR of the collection of vital data advantageously includes, as indicated in FIG. 4b, a first step 171 for accessing, in read mode, the means MR for storing a vital data collection history. A step 172 constitutes a predetermined view by selecting certain fields or elements of each record. This selection operation seeks to conceal certain information related to the patient and/or the healthcare staff member having initiated the vital data measurements Da. Different selection rules can be pre-established depending on the type of measuring devices in question. The method 170 lastly includes a step 173 for controlling the means 15 to encode such a view and produce a consultation message Mgo.

Like the communicating 20, 20a, 20b or administration 6 devices, a platform 10 according to the invention includes program memory means MW for recording one or several computer programs including a plurality of program instructions, which, when executed or interpreted by the processing unit 19, cause the implementation of a method accessing, in write and/or read mode, the memory means of the platform. It is thus possible to load, in said memory means MW, any program making it possible to initialize or update the instructions making it possible to implement the methods 110, 120, 130, 140, 150, 160, 170 as well as management rules for the collected data.

A system for collecting and managing vital data Da of a patient Pi, Pj, illustrated as a non-limiting example in connection with FIG. 3, globally comprises:
a server 1 for storing a plurality of electronic medical records DPi;
a plurality of measuring devices Ax, Ay, Az, each delivering vital data Da for patients Pi, Pj;
a platform 10 for managing and collecting said vital data Da cooperating with said measuring devices Ax, Ay, Az, and said server 1;
one or several communicating devices 20, 20a or 20b intended to be used by the healthcare staff member Ia, Ib to record any association or dissociation between said measuring devices and the patients;
an administration device 6, optionally, in particular for updating the repository of measuring devices and providing management of said devices in light of their respective uses in the healthcare establishment.

In the preferred example described in connection with FIG. 3, a measuring device Ax, Ay or Az, a communicating device 20, 20a or 20b, an administration device 6, a server 1 for electronic medical records, respectively communicate with the platform 10 using communication networks N1, N2, N3 and N shown in FIG. 3 as separate networks. Such networks can alternatively, in combination, constitute a single and same physical entity. To that end, the means C1, C2, C3 and C allowing the platform 10 to receive or send messages on the networks N, N1, N2, N3 can also constitute separate physical entities, or alternatively, in combination, can constitute a same physical entity.

1. A platform for collecting and managing vital data of a patient, said data being delivered by a medical measuring device being associated with a unique identifier and cooperating with said platform using one or several data messages, said platform further cooperating with an electronic medical record server and including a processing unit, said processing unit comprising:
means for receiving a data message and means for decoding said message and deducing the identifier therefrom of the measuring device and the vital data delivered by the latter;
management means, cooperating with said means for decoding a data message, for selecting and aggregating vital data thus determined and producing an update request of an electronic medical record;
means for encoding such an update request of an electronic medical record and produce an update message sent to the electronic medical record server;
wherein said platform further comprises:
means for storing a repository of patients including, for each patient, a record comprising a unique identifier characterizing the identity of said patient and a patient descriptor;
means for storing a repository of measuring devices including, for each measuring device, a record comprising the identifier of said device and a device descriptor;
means for receiving a care management message, coming from a device cooperating with the platform, encoding a request for association or dissociation of a measuring device and a patient, said request including a unique identifier of the healthcare staff member initiating said association or dissociation, and means for decoding such a message and deducing therefrom the respective identifiers of the measuring device, the healthcare staff member and the patient affected by that request;
and wherein the management means are configured to:
after decoding of a care management message by said means for decoding such a message, implement a care management method to record, in the means for storing a repository of devices, an association or dissociation of a measuring device and a patient, as well as the identifier of the healthcare staff member initiating said association or dissociation;
after the decoding of a data message by the means for decoding such a data message, implement a method requesting an update of the electronic medical record associated with the patient related to the vital data thus collected by the platform, said method requesting an update of an electronic medical record being suitable for integrating the unique identifier of the healthcare staff member in the request to update the electronic medical record.

2. The platform according to claim 1, further including means (MR) for recording a history of vital data collection, said history including a plurality of records, and wherein the management means implement a traceability method to determine the content of a record of said history in response to the decoding of any data message.

3. The platform according to claim 1, wherein:
a data message further includes additional measurement data associated with the vital data of a patient;
the means for decoding a data message deduce said additional measurement data therefrom.

4. The platform according to claim 1, wherein:
a care management message further encodes additional care data associated with the request for association or dissociation;
the means for decoding a care management message deduce said additional care data therefrom.

5. The platform according to claim 3, wherein the additional measurement or care data includes a timestamp and/or a descriptor of the measuring device.

6. The platform according to claim 1, wherein:
the management means are adapted to implement a method for determining an association state of a measuring device;
the processing unit includes:
means for encoding said association state in the form of a device association state message;
means for sending such a message to a device cooperating with the platform.

7. The platform according to claim 2, wherein:
the management means are suitable for implementing a method for consulting a vital data collection history;
the processing unit includes:
means for encoding a view of the vital data collection history, said view resulting from the implementation of said method, in the form of one or several consultation messages;
means for sending said one or several messages to an administration device cooperating with the platform.

8. The platform according to claim 1, wherein:
the processing unit includes:
means for receiving an administration message coming from an administration device cooperating with the platform, said message encoding an update request of the repository of devices, said request including a unique identifier of a measuring device and a descriptor of said measuring device;
means for decoding such a message and deducing the identifier and descriptor of the measuring device affected by the request therefrom;
the management means are configured, after decoding of an administration message by said means to decode such a message, to implement an update method of the repository of devices to create a new record associated with the measuring device or to update a record previously associated with the latter.

9. The platform according to claim 1, wherein:
the processing unit includes:
means for receiving a patient follow-up message coming from an electronic medical record server cooperating with the platform, said message encoding a request to update the repository of patients, said request including a unique identifier of a patient and a descriptor of said patient;
means for decoding such a message and deducing the identifier and descriptor therefrom of the patient affected by the request;
the management means are configured, after decoding of a patient follow-up message by said means for decoding such a message, to implement a method for updating the repository of patients to create a new record associated with the patient or to update a record previously associated with the latter.

10. The platform according to claim 1, including program memory means to store a computer program including a plurality of program instructions which, when executed or interpreted by the processing unit, cause the implementation of a method accessing, in write and/or read mode, the memory means of the platform.

11. A care management method, said method being implemented by the management means of the processing unit of a platform for collecting and managing vital data of a patient according to claim 1, in response to the decoding of a care management message encoding a request for association (+) of a measuring device and a patient, steps for:
looking in the repository of devices for a record comprising the device identifier previously deduced from said care management message;
writing, in said record, an association information with a record of the repository of patients, said record including the patient identifier and the identifier of the healthcare staff member also previously deduced from said care management message.

12. A care management method, said method being implemented by the management means of the processing unit of a platform for collecting and managing vital data of a patient according to claim 1, in response to the decoding of a care management message encoding a request for dissociation (−) of a measuring device and a patient, steps for:
looking, in the repository of devices, for a record comprising the device identifier previously deduced from said care management message;
erasing or eliminating, in said record, the association information with a record of the repository of patients, said record including the patient identifier and the identifier of the healthcare staff member, also previously deduced from said care management message.

13. A method for requesting an update of an electronic medical record, said method being implemented by the management means of the processing unit of a platform (10) for collecting and managing vital data of a patient according to claim 1, in response to the decoding of a data message, said method including steps for:
looking, in the repository of devices, for a record comprising the device identifier deduced from the data message;
reading the association information designating a record of the repository of patients and the identifier of the healthcare staff member initiating the association of the measuring device and the patient;
looking for said associated record in the repository of patients and reading the identifier of the patient contained in said associated record;
generating an update request of the electronic medical record including the identifier of the patient, the identifier of the healthcare staff member and the vital data deduced from the data message previously decoded;
controlling the means for encoding such an update request of an electronic medical record and producing an update message sent to the electronic medical record server.

14. A method for updating the repository of measuring devices, said method being implemented by the management means of the processing unit of a platform for collecting and managing vital data of a patient according to claim 8, in response to the decoding of an administration message, said method including steps for:
looking in the repository of devices for a record comprising the device identifier previously deduced from the administration message;
in the affirmative, updating the descriptor of the measuring device in said record;
in the negative, creating a new record in the repository of devices and writing the identifier of the device therein as well as the descriptor of said device, previously deduced from the administration message.

15. A traceability method, implemented by the management means of the processing unit of a platform for collecting and managing vital data of a patient according to claim 2, in response to the decoding of a data message, said method including steps for:
creating a record in the means for storing the history;
writing, in said record, all of the elements deduced of said data message;
looking, in the repository of devices, for the record including the device identifier deduced from the data message;
reading the association information of said record and the identifier of the healthcare staff member initiating the association of the device and the patient;
looking for the associated record in the repository of patients;
if the latter exists, reading the identifier of the patient related to the data measurement collection;
writing, in the record of the history, said identifier of the patient and said identifier of the healthcare staff member.

16. A method for consulting a vital data collection history, said method being implemented by the management means of the processing unit of a platform for collecting and managing vital data of a patient according to claim 2, said method including steps for:
accessing, in read mode, the means for storing (MR) a vital data collection history;
constituting a predetermined view of fields of each record;
controlling the means to encode such a view and producing a consultation message.

17. A method for updating the repository of patients, said method being implemented, by the management means of the processing unit of a platform for collecting and managing vital data of a patient according to claim 9, in response to the decoding of a patient follow-up message, said method including steps for:
looking, in the repository of devices, for a record comprising the identifier of the patient previously deduced from the patient follow-up message;
in the affirmative, updating the descriptor of the patient in said record;
in the negative, creating a new record in the repository of patients and writing the identifier of the patient therein, as well as the descriptor of the patient, previously deduced from the patient follow-up message.

18. A method for determining an association status of a measuring device, said method being implemented by the management means of the processing unit of a platform for collecting and managing vital data of a patient according to claim 6, said method including steps for:
accessing, in read mode, the means for storing the repository of devices;
constituting a predetermined view of the fields of each record;
controlling the means to encode such a view and producing an association status message of the device.

19. A computer program including a plurality of program instructions which, when executed or interpreted by the processing unit of a platform, cause the implementation of the method according to claim 11, said program being able to be loaded in program memory means of said platform.

20. A communicating device intended to be used by a healthcare staff member, wherein it includes:
means for cooperating with a platform for collecting and managing vital data of a patient according to claim 1;
a man-machine input interface for translating a selection action of said healthcare staff member into a determination of an identifier of a measuring device, an identifier of the patient, an association or dissociation operation of said measuring device and said patient as well as a unique identifier of said healthcare staff member;
a processing unit cooperating with said means for cooperating with a platform and said man-machine input interface;
and wherein said processing unit is suitable for carrying out a method for generating and sending a care management message encoding a request to associate or dissociate a vital data measuring device and a patient, said request including the identifier of the healthcare staff member, the identifier of the measuring device, the identifier of the patient, the association or dissociation operation of said measuring device and said patient initiated by the healthcare staff member.

21. The communicating device according to claim 1, further including a man-machine output interface (23) cooperating with the processing unit of the device, wherein:
the means for cooperating with the platform are further configured to receive a device association status message coming from the platform and encoding an association status of a measuring device;
the processing unit is configured to implement an association status consultation method of a measuring device in response to the receipt of said device association status message.

22. A method for generating a care management message encoding a request to associate or dissociate a vital data measuring device and a patient, said method being implemented by the processing unit of a communicating device according to claim 20, wherein it includes steps for:
steering the man-machine input interface translating a selection action by a user to determine the unique identifier of a measuring device, the unique identifier of a patient, the association or dissociation operation of said measuring device and said patient and the identifier of the healthcare staff member initiating said association or dissociation;
depending on the determined association or dissociation operation, respectively producing a request to associate or dissociate the measuring device and the patient whose respective identifiers have been determined, said request including the identifier of the healthcare staff member (Ia, Ib) initiating said association or dissociation;
encoding said request and producing a care management message;
controlling the sending of said message by the means for cooperating with the platform (10).

23. A method for consulting an association status of a measuring device, said method being implemented by the processing unit of a communicating device according to claim 21, wherein it includes steps for:
following the receipt of a device association state message, decoding such a message and deducing therefrom the identifier of said measuring device, an identifier of a patient associated with said device and the identifier of the healthcare staff member initiating said association, or a predetermined value reflecting a non-association with a patient;
controlling the output of said identifiers and/or predetermined value by the man-machine output interface to a user of the communicating device.

24. An administration device, wherein it includes:
means for cooperating with a platform for collecting and managing vital data of a patient according to claim 8;
a man-machine input interface for translating a selection action by a user of said administration device into a determination of an identifier of a measuring device and a descriptor specific to said measuring device;
a processing unit cooperating with said means to cooperate with the platform and said man-machine input interface;
and, wherein said processing unit is suitable for implementing a method for generating and sending an administration message, said message encoding an update request of the repository of devices of the platform.

25. The administration device according to claim 1, further including a man-machine output interface cooperating with the processing unit of said device, and wherein:
the means for cooperating with the platform are further configured to receive a consultation message coming from the platform and encoding a view of the collection history of vital data from the platform;
the processing unit is further configured to implement a method for supervising the operation of measuring devices, in response to the reception of said consultation message.

26. A method for generating an administration message, said method being implemented by the processing unit of an administration device according to claim 24, wherein it includes steps for:
steering the man-machine input interface reflecting a selection action by a user of the administration device to determine an identifier and a descriptor of a measuring device;
producing an update request of the repository of devices of the platform including said identifier and descriptor of the measuring device;
encoding said request in the form of an administration message;
controlling the sending of said message by the means to cooperate with the platform.

27. A method for supervising the operation of measuring devices, said method being implemented by the processing unit of an administration device according to claim 25, wherein it includes steps to:
after receipt of a consultation message coming from the platform, decoding such a message and deduce therefrom a view of the vital data collection history of the platform;
implementing a processing of said view and produce synthesis data thereof;
controlling the output of said synthesis data by the man-machine output interface for a user of said administration device.

28. A system for collecting and managing vital data of a patient, comprising:
a server for storing a plurality of electronic medical records;
a plurality of measuring devices each delivering vital patient data;
a platform for managing and collecting said vital data cooperating with said measuring devices and said server;
wherein said platform is according to claim 1 and in that said system further includes one or several communicating devices cooperating with said platform.

29. The system according to claim 28, further comprising an administration device cooperating with the platform.

30. A computer program including a plurality of program instructions which, when executed or interpreted by the processing unit of a communicating device, causes the implementation of a method according to claim 22, said communicating device further including memory means within which the program can be loaded.

31. A computer program including a plurality of program instructions which, when executed or interpreted by the processing unit of an administration device, causes the implementation of a method according to claim 26, said administration device further including memory means within which the program can be loaded.
